(19) United States
(12) Patent Application Publication
(10) Pub. No.: US 2026/0255045 A1
(43) Pub. Date: Aug. 27, 2026

(54) HIGH RESOLUTION ELECTRONIC DEVICE

(71) Applicant: Samsung Electronics Co., Ltd., Suwon-si (KR)

(72) Inventors: Kyu-Min KYUNG, Suwon-si (KR); Shung Han CHO, Suwon-si (KR); Gilseong HEO, Suwon-si (KR); Jinmyeong KIM, Suwon-si (KR)

(73) Assignee: Samsung Electronics Co., Ltd., Suwon-si (KR)

(21) Appl. No.: 19/418,233

(22) Filed: Dec. 12, 2025

(30) Foreign Application Priority Data
Feb. 27, 2025 (KR) 10-2025-0026209
Aug. 28, 2025 (KR) 10-2025-0121363

(51) Int. Cl. H04N 23/611; G06T 7/246; G06V 10/147; G06V 10/25; G06V 10/26; H04N 23/63; H04N 23/69

(52) U.S. Cl. CPC H04N 23/611; G06T 7/248; G06V 10/147; G06V 10/25; G06V 10/267; H04N 23/634; H04N 23/635; H04N 23/69; G06T 2207/20104

(57) ABSTRACT

An electronic device including a camera device that generates a raw image signal on a frame-by-frame basis; a subject identification circuit that determines information on a group of region of interest candidates based on the raw image signal and generates a region of interest signal indicating at least one region of interest candidate among a plurality of region of interest candidates included in the information on the group of region of interest candidates; an image signal processor that generates a first image based on the raw image signal, and generates a second image based on the region of interest signal, the region of interest signal including offset information, and the offset information being a distance from a center region of the first image to the at least one region of interest candidate; and a display panel that displays the first image and the second image.

### CROSS-REFERENCE TO RELATED APPLICATION

This application claims priority to and the benefit of Korean Patent Application No. 10-2025-0026209 filed with the Korean Patent Office on Feb. 27, 2025, and No. 10-2025-0121363 filed with the Korean Patent Office on Aug. 28, 2025, the entire contents of which are incorporated herein by reference.

### BACKGROUND

The present disclosure relates to electronic devices and methods of driving electronic devices.

When users take pictures or videos with electronic devices, it is difficult for the electronic devices to accurately capture the subject due to issues such as the angle of view, zoom method, and resolution degradation.

A wide-angle lens may capture a wide range of objects, but the subject appears small and is difficult to distinguish from the background. On the other hand, a telephoto lens may capture a large subject, but the angle of view is narrow, so there is a high possibility of missing the subject.

When using digital zoom, the image is simply enlarged, so pixel loss occurs and image quality deteriorates. Optical zoom does not deteriorate image quality, but has limitations on general smartphones.

Tracking fast-moving subjects may be difficult, resulting in subjects moving out of the field of view or out of focus.

Accordingly, it is not easy for users to take clear pictures of the desired subject.

### SUMMARY

Some example embodiments of the inventive concepts provide an electronic device and a method of driving the electronic device for implementing high resolution in a non-central region of interest.

Some example embodiments provide an electronic device that provides a picture-related UX (e.g., user experience) and a method of operating the electronic device.

Some example embodiments of the inventive concepts provide an electronic device that includes a camera device that generates a raw image signal on a frame-by-frame basis; a subject identification circuit that determines information on a group of region of interest candidates based on the raw image signal and generates a region of interest signal indicating at least one region of interest candidate among a plurality of region of interest candidates included in the information on the group of region of interest candidates; an image signal processor that generates a first image based on the raw image signal, and generates a second image based on the region of interest signal, the region of interest signal including offset information, and the offset information being a distance from a center region of the first image to the at least one region of interest candidate; and a display panel that displays the first image and the second image.

Some example embodiments further provide an electronic device that includes a first camera that generates first raw image data on a frame-by-frame basis; a subject identification circuit that determines information about a group of region of interest candidates based on the first raw image data and generates a region of interest signal indicating at least one region of interest candidate among a plurality of region of interest candidates included in the information about the group of region of interest candidates; a second camera that generates second raw image data based on the region of interest signal; an image signal processor that generates a first image based on the first raw image data, and generates a second image based on the second raw image data, the region of interest signal including offset information, and the offset information being a distance from a center region of the first image to the at least one region of interest candidate; and a display panel that displays the first image and the second image.

Some example embodiments still further provide an operation method of an electronic device that includes generating, by an image sensor, raw image data on a frame-by-frame basis; converting, by an image sensor interface, the raw image data into a raw image signal; determining, by a subject identification circuit, information on a group of region of interest candidates based on the raw image signal; generating, by the subject identification circuit, a region of interest signal indicating at least one region of interest candidate among a plurality of region of interest candidates included in the information on the group of region of interest candidates; generating, by an image signal processor, a first image based on the raw image signal; generating, by the image signal processor, a second image based on the region of interest signal, the region of interest signal including offset information, and the offset information being a distance from a center region of the first image to the at least one region of interest candidate; and displaying the first image and the second image in different areas on a display panel.

### BRIEF DESCRIPTION OF THE DRAWINGS

FIG. 1 is a block diagram of an electronic device according to some example embodiments of the inventive concepts.

FIG. 2 is a block diagram of a subject identification circuit according to some example embodiments.

FIG. 3 is a diagram showing information about candidate regions of interest according to some example embodiments.

FIG. 4 is a diagram showing information about a previous candidate region of interest according to some example embodiments.

FIG. 5 is a diagram showing a region of interest signal according to some example embodiments.

FIG. 6 is a diagram illustrating a process for generating a first image according to some example embodiments.

FIG. 7 is a drawing showing a first image according to some example embodiments.

FIGS. 8 and 9 are drawings showing a second image according to some example embodiments.

FIG. 10 is a drawing showing a user's swipe input on a display panel.

FIG. 11 is a drawing showing a 2-1 image generated based on a user's swipe input.

FIG. 12 is a drawing showing a 2-2 image generated based on a user's swipe input.

FIG. 13 is a diagram showing a user's zoom swipe input on a display panel.

FIG. 14 is a drawing showing a 2-1 image generated based on a user's zoom swipe input.

FIG. 15 is a drawing showing a 2-2 image generated based on a user's zoom swipe input.

FIG. 16 is a drawing showing a 2-3 image generated based on a user's zoom swipe input.

FIG. 17 is a drawing showing that the position of the region of interest on the display panel is fixed.

FIG. 18 is a drawing showing that the position of the region of interest on the display panel is not fixed.

FIG. 19 is a drawing showing a some example embodiments where a subject corresponding to a region of interest on a display panel temporarily disappears.

FIG. 20 is a front view and a back view of an electronic device according to some example embodiments.

FIG. 21 is a block diagram of an electronic device according to some example embodiments.

FIG. 22 is a block diagram of an electronic device according to some example embodiments.

FIG. 23 is a block diagram of a subject identification circuit according to some example embodiments.

FIG. 24 is a drawing showing a first image and guide object according to some example embodiments.

FIG. 25 is a drawing showing a second image according to some example embodiments.

FIG. 26 is a block diagram of an electronic device according to some example embodiments.

FIG. 27 is a flowchart showing the process of generating the first image and the second image.

### DETAILED DESCRIPTION

Below, with reference to the attached drawings, some example embodiments of the present inventive concepts are described in detail so that a person having ordinary skill in the art to which the present inventive concepts pertains may easily practice the present inventive concepts. However, the present inventive concepts may be implemented in various different forms and is not limited to some example embodiments described herein.

And in order to clearly explain the present inventive concepts in the drawings, parts that are not related to the explanation are omitted, and similar parts are given similar drawing reference numerals throughout the specification. In the flowchart described with reference to the drawings, the order of operations may be changed, several operations may be merged, some operations may be split, and certain operations may not be performed.

Additionally, expressions written in the singular may be interpreted as singular or plural, unless explicit expressions such as “one” or “singular” are used. Terms that include ordinal numbers, such as first, second, etc., may be used to describe various components, but the components are not limited by these terms.

These terms may be used to distinguish one component from another. Hereinafter, the present disclosure will be described in more detail by way of examples. These examples are intended only to illustrate the present disclosure, and the scope of protection of the rights of the present disclosure is not limited by these examples.

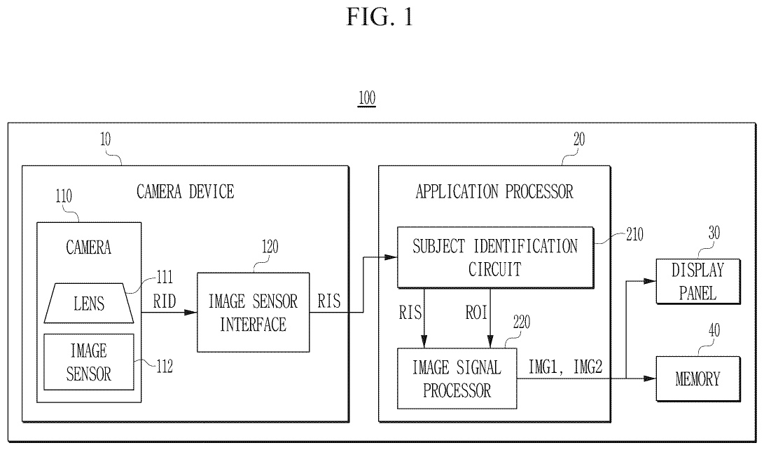

FIG. 1 is a block diagram of an electronic device according to some example embodiments.

Referring to FIG. 1, an electronic device 100 may include a camera device 10, an application processor 20, a display panel 30, and a memory 40.

The camera device 10 may capture a subject on a frame-by-frame basis and generate a raw image data RID. The raw image data RID may be unprocessed image data that includes the plurality of subjects and surrounding backgrounds of the plurality of subjects. The camera device 10 may convert the raw image data RID into a raw image signal RIS. The raw image signal RIS may be converted by serializing the raw image data RID. The camera device 10 may transmit the raw image signal RIS to the application processor 20. The camera device 10 may include a camera 110 and an image sensor interface 120.

The camera 110 may include a lens 111. The camera 110 may receive optical signals reflected from the plurality of subjects through the lens 111. The lens 111 may be a wide-angle lens or an ultra-wide-angle lens. Ultra wide-angle lenses may provide a wider field of view than wide-angle lenses. A wide-angle lens may have a focal length greater than 24 mm and less than or equal to 35 mm. The angle of view of a wide-angle lens may be greater than 78° and less than 80°. Ultra wide-angle lenses may have a focal length of less than 24 mm. The angle of view of an ultra-wide-angle lens may be greater than 110° and less than 120°. The focal lengths and angles of view of the wide-angle and ultra-wide-angle lenses described above are only examples.

The camera 110 may include an image sensor 112. The image sensor 112 may generate the raw image data RID based on an optical signal collected through the lens 111. The image sensor 112 may include a pixel array, an analog-to-digital converter A/D converter, and a demosaic circuit. A pixel array may contain more than 200 million pixels. Accordingly, the image sensor 112 may implement a resolution of 200 MP Megapixel or more. The number of pixels and resolution are not limited to this.

A plurality of pixels included in the pixel array may detect light of a specific color and convert the intensity and color information of the detected light into an electrical signal. An A/D converter may convert electrical signals into digital data. The converted digital data may only contain color information for specific colors.

The demosaicing circuit may interpolate color information based on digital data from adjacent pixels to compensate for color information not included in the converted digital data. For example, if the first digital data corresponding to the first pixel in the pixel array contains only color information for the red color, the demosaic circuit may interpolate the green color value of the first digital data using the green color information contained in the second digital data corresponding to the second pixel adjacent to the first pixel.

The image sensor 112 may generate the raw image data RID by arranging interpolated digital data according to the row and column coordinates of each pixel within the pixel array. The raw image data RID may be organized in a two-dimensional matrix format. For example, if a first pixel included in a pixel array is located in row 1 and column 1, the image sensor 112 may place the interpolated digital data of the first pixel in row 1 and column 1 within the raw image data RID. When the second pixel is located in row 1 and column 2, the image sensor 112 may place the interpolated digital data of the second pixel in row 1 and column 2 within the raw image data RID.

The image sensor 112 may transmit the raw image data RID to the image sensor interface 120. The image sensor 112 may be a CCD (Charge-Coupled Device) sensor or a CMOS (Complementary Metal-Oxide-Semiconductor) sensor.

The image sensor interface 120 may mediate the transmission or reception of data between the camera 110 and the application processor 20. The image sensor interface 120 may receive the raw image data RID from the camera 110. The image sensor interface 120 may convert the raw image data RID into a signal form that may be transmitted to the application processor 20. The image sensor interface 120 may serialize the raw image data RID generated in frame units and convert it into raw image signals RIS in the same frame units. The image sensor interface 120 may transmit the raw image signal RIS to the application processor 20.

The application processor 20 may include a subject identification circuit 210 and an image signal processor 220. The subject identification circuit 210 may receive the raw image signal RIS from the image sensor interface 120. The subject identification circuit 210 may detect a subject based on the raw image signal RIS and determine information on a candidate region of interest based on the moving speed of the subject. Information about candidate regions of interest may include the plurality of candidate regions of interest. The subject identification circuit 210 may select at least one region of interest candidate from among a plurality of region of interest candidates to generate a region of interest signal ROI. The subject identification circuit 210 may transmit the raw image signal RIS and a region of interest signal ROI to an image signal processor 220.

The image signal processor 220 may generate a first image IMG1 based on the raw image signal RIS. The image signal processor 220 may generate a second image IMG2 based on the region of interest signal ROI.

The region of interest signal ROI may include offset information, which is the distance from the center region of the first image IMG1 to the region of interest candidate. The center area of the first image IMG1 may be set based on the middle row and middle column determined based on the number of pixels of the first image IMG. The positions of the middle row and middle column may have a certain range of errors. For example, if the size of the first image IMG1 is 100×100 pixels, and the positions of the middle row and the middle column are allowed a range error of 3 pixels each, the middle row may be the 47th to 53rd row, and the middle column may be the 47th to 53rd column.

The offset information may mean the pixel distance between the region of interest candidates from the center region of the first image IMG1. The pixel distance may be computed as the sum of the row-wise pixel distance to the middle row and the region of interest candidate and the column-wise pixel distance to the middle column and the region of interest candidate.

The second image IMG2 may be generated by cropping an area within the first image IMG1 corresponding to the region of interest signal ROI using offset information. If the region of interest candidate is included in the center region of the first image IMG1, the center region of the second image IMG2 may be identical to the center region of the first image IMG1. If the region of interest candidate is not included in the center region of the first image IMG1, the center region of the second image IMG2 may be different from the center region of the first image IMG1.

The image signal processor 220 may transmit the first image IMG1 and the second image IMG2 to the display panel 30 and the memory 40.

The display panel 30 may display an image generated by the image signal processor 220. The image signal processor 220 may display information about the first image IMG1 and candidate regions of interest on the first area of the display panel 30. The image signal processor 220 may display the second image IMG2 in a second area different from the first area of the display panel 30.

The memory 40 may receive a first image IMG1 and a second image IMG2 from the image signal processor 220. The memory 40 may store a first image IMG1 and a second image IMG2. The memory 40 may be volatile memory and/or non-volatile memory.

The electronic device 100 of the present disclosure may be a smartphone, a tablet PC, or a wearable device. However, it is not limited to this.

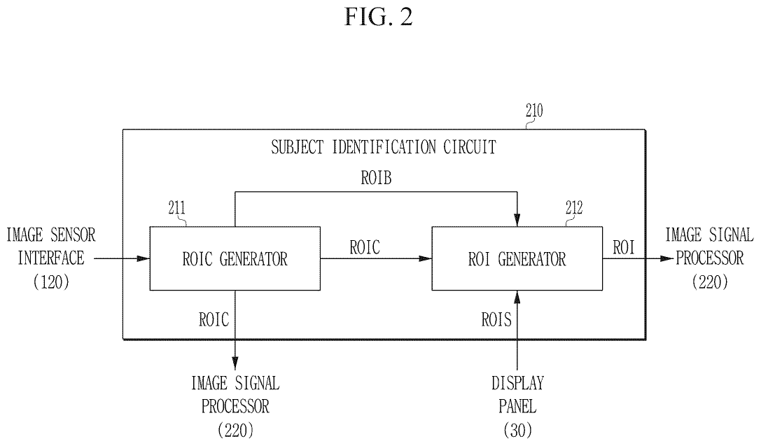

FIG. 2 is a block diagram of a subject identification circuit according to some example embodiments.

Referring to FIG. 2, the subject identification circuit 210 may include a region of interest candidate generator 211 and a region of interest signal generator 212. The region of interest candidate generator 211 may receive the raw image signal RIS from the image sensor interface 120.

The region of interest candidate generator 211 may identify a subject (e.g., a subject captured by the camera device 10) and the moving speed of the subject based on the raw image signal RIS and generate subject identification information and subject moving speed information. The subject's identification information may include the subject's type as object information. The subject's movement speed information may include the subject's current speed, movement direction, and acceleration.

The region of interest candidate generator 211 may determine information about a region of interest candidate ROIC based on the subject's identification information and the subject's movement speed information. Information about the region of interest candidate ROIC may include the plurality of candidate regions of interest.

For example, the region of interest candidate generator 211 may analyze the subject's identification information and determine a person as a region of interest candidate if the person is included in a background such as a tree or building. The region of interest candidate generator 211 may determine a running person as a region of interest candidate when a stationary person and a running person exist together by considering the moving speed.

The region of interest candidate generator 211 may transmit information about the region of interest candidate ROIC to the region of interest signal generator 212. The region of interest signal generator 212 may generate a region of interest signal ROI indicating at least one region of interest candidate among a plurality of region of interest candidates included in information about the region of interest candidate ROIC.

In some example embodiments, the region of interest signal generator 212 may generate a region of interest signal ROI using information about a previous region of interest candidate ROIB. Information about the previous region of interest candidate ROIB may be determined based on the previous raw image signal generated from the frame before the raw image signal RIS is generated. The region of interest signal generator 212 may receive information on previous region of interest candidate ROIB from the region of interest candidate generator 211.

The region of interest signal generator 212 may determine whether a region of interest candidate included in the information about the region of interest candidate ROIC is identical to a previous region of interest candidate included in the information on previous region of interest candidate ROIB. The region of interest signal generator 212 may determine that the region of interest candidate and the previous region of interest candidate are the same if the identification information of the subject corresponding to the region of interest candidate is the same as the identification information of the subject corresponding to the previous region of interest candidate.

The region of interest signal generator 212 may generate a region of interest signal ROI by selecting a region of interest candidate that is identical to a plurality of previous region of interest candidates included in the information on previous region of interest candidate ROIB from the information about the region of interest candidate ROIC. The region of interest signal generator 212 may transmit a region of interest signal ROI to an image signal processor 220.

In some example embodiments, the region of interest signal generator 212 may generate a region of interest signal ROI based on a user input indicating at least one region of interest candidate among a plurality of region of interest candidates included in a region of interest candidate information set ROIC.

The region of interest candidate generator 211 may transmit information about the region of interest candidate ROIC to the image signal processor 220. The image signal processor 220 may display information about the region of interest candidate ROIC on a first area of the display panel 30. The display panel 30 may generate a region of interest selection signal ROIS based on a user's input selecting at least one region of interest candidate from among a plurality of region of interest candidates. The display panel 30 may transmit a region of interest selection signal ROIS to the region of interest signal generator 212. The region of interest signal generator 212 may generate a region of interest signal ROI indicating at least one region of interest candidate among a plurality of region of interest candidates based on a region of interest selection signal ROIS. The region of interest signal generator 212 may transmit a region of interest signal ROI to an image signal processor 220.

As will be subsequently described in greater detail, in some example embodiments, the electronic device 100 may thus enable user selection and tracking of multiple objects (e.g., subjects), so that the user may intuitively select a desired object and a zoom effect may correspondingly be applied to images by the electronic device 100. The first image IMG1, and the second images IMG2 having zoom effect applied thereto, may be stored in memory 40. Some example embodiments thus provide an electronic device that may provide images having improved zoom effect while also providing improved user experience.

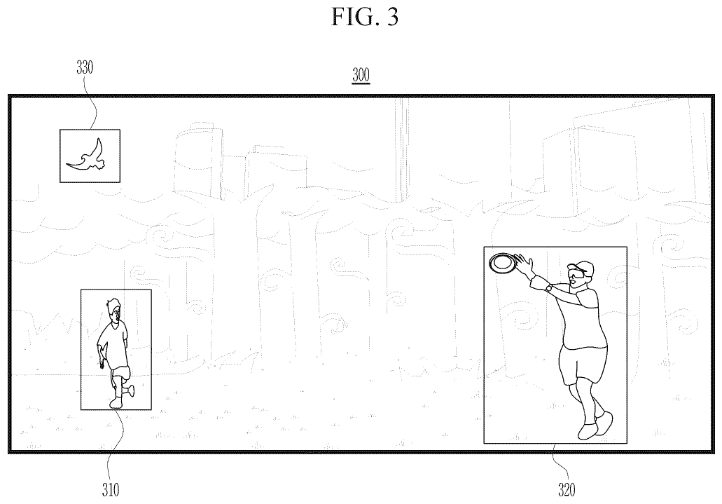

FIGS. 3 to 5 are diagrams showing information about a candidate region of interest, information about a previous candidate region of interest, and a region of interest according to some example embodiments.

Referring to FIG. 3, the image signal processor 220 of FIG. 2 may display information about the region of interest candidate ROIC of FIG. 2 through a display panel 30 of FIG. 1. The point in time when information about the region of interest candidate ROIC is displayed may be the first frame. Information about the region of interest candidate ROIC may include a first region of interest candidate 310, a second region of interest candidate 320, and a third region of interest candidate 330.

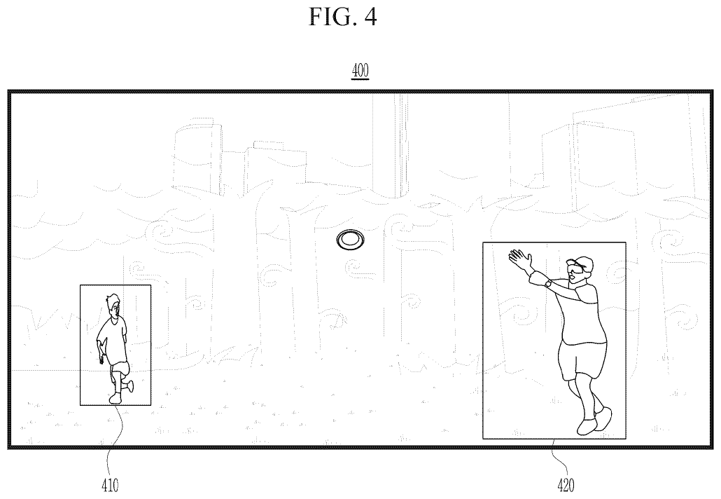

Referring to FIG. 4, the region of interest signal generator 212 of FIG. 2 may receive information on the previous region of interest candidate ROIB of FIG. 2 from the region of interest candidate generator 211 of FIG. 2. The time at which information on previous region of interest candidate ROIB is generated may be the second frame. The second frame may be earlier than the first frame. Information on previous region of interest candidate ROIB may include a first previous region of interest candidate 410 and a second previous region of interest candidate 420. The identification information of the first previous region of interest candidate 410 may be identical to the identification information of the first region of interest candidate 310 as a male child. The identification information of the second previous region of interest candidate 420 may be identical to the identification information of the second region of interest candidate 320 as an adult male. The previous region of interest candidate corresponding to the third region of interest candidate 330 may not be included in the information on the previous region of interest candidate group ROIB.

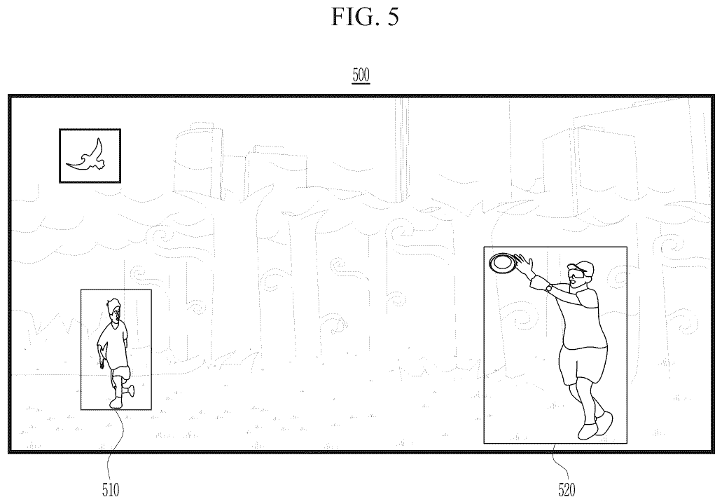

Referring to FIG. 5, the region of interest signal generator 212 may select a region of interest candidate that is identical to a plurality of previous region of interest candidates included in the information on previous region of interest candidate ROIB from the information about the region of interest candidate ROIC. An identical region of interest candidate may mean a region of interest candidate whose subject identification information is the same as that of a previous region of interest candidate. The region of interest signal generator 212 may generate a region of interest signal ROI based on a selected region of interest candidate.

The region of interest signal generator 212 may generate a first region of interest signal by selecting a first region of interest candidate 310 included in the information about the region of interest candidate ROIC. The region of interest signal generator 212 may generate a second region of interest signal by selecting a second region of interest candidate 320 included in the information about the region of interest candidate ROIC. The region of interest signal generator 212 may transmit the first region of interest signal and the second region of interest signal to the image signal processor 220.

The image signal processor 220 may display a region of interest corresponding to a region of interest signal ROI through a display panel 30. The image signal processor 220 may display a first region of interest 510 corresponding to the first region of interest signal on the display panel 30. The image signal processor 220 may display a second region of interest 520 corresponding to the second region of interest signal on the display panel 30. The first region of interest 510 may be identical to the first region of interest candidate 310. The second region of interest 520 may be identical to the second region of interest candidate 320.

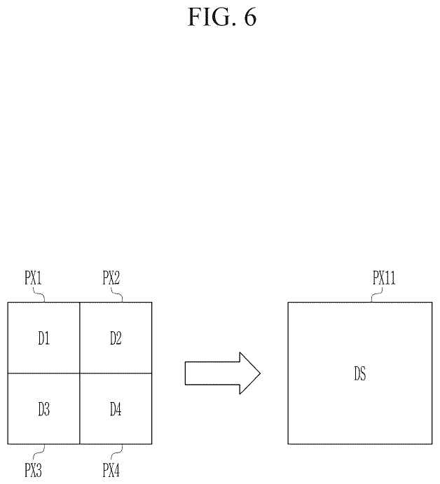

FIG. 6 is a diagram illustrating a process for generating a first image according to some example embodiments. Referring to FIG. 6, the image signal processor 220 of FIG. 1 may perform a binning operation to generate a first image IMG1 of FIG. 1. Binning operations may produce a single pixel value by averaging the values of the plurality of pixels. For example, 4:1 binning would average four pixel values to produce one pixel value. The first pixel PX1 may have a value D1, and the second pixel PX2 may have a value D2. The third pixel PX3 may have a value of D3, and the fourth pixel PX4 may have a value of D4. The pixel PX11 after binning may have the value D1+D2+D3+D4/4. The binning ratio is not limited to this.

If the resolution of the image sensor 112 in FIG. 1 is 200 MP, the raw image signal RIS in FIG. 1 may contain more than 200 million pixel values. A binning operation may be performed in the image signal processor 220 to match the number of pixels included in the display panel 30. The binning ratio may also be adjusted. As the binning ratio increases, the size of the first image IMG1 displayed on the display panel 30 in FIG. 1 may be reduced.

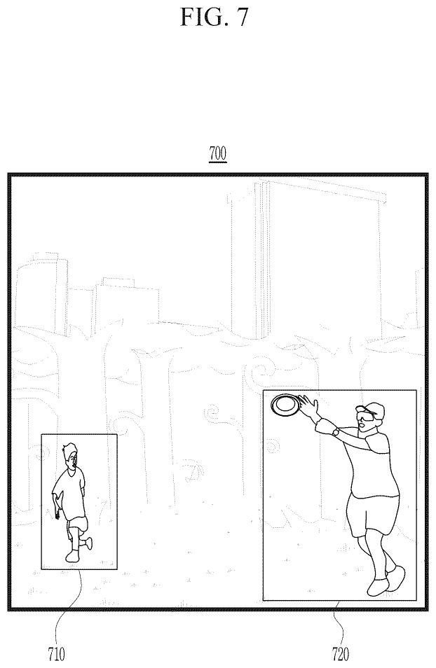

FIG. 7 is a drawing showing a first image according to some example embodiments.

Referring to FIG. 7, the image signal processor 220 of FIG. 1 may generate a first image 700 through a binning operation targeting the raw image signal RIS of FIG. 1. The binning ratio may be 16:1. The image signal processor 220 may display the first image 700 through the display panel 30 in FIG. 1. The first image 700 may have a 4K resolution. Binning ratios and resolutions are examples only.

The first image 700 may include a first region of interest 710 and a second region of interest 720. The first region of interest 710 may be generated based on the raw image signal RIS corresponding to the first region of interest 510 in FIG. 5. The second region of interest 720 may be generated based on the raw image signal RIS corresponding to the second region of interest 520 of FIG. 5.

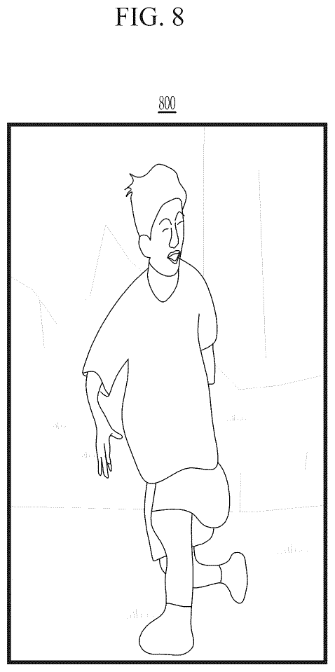

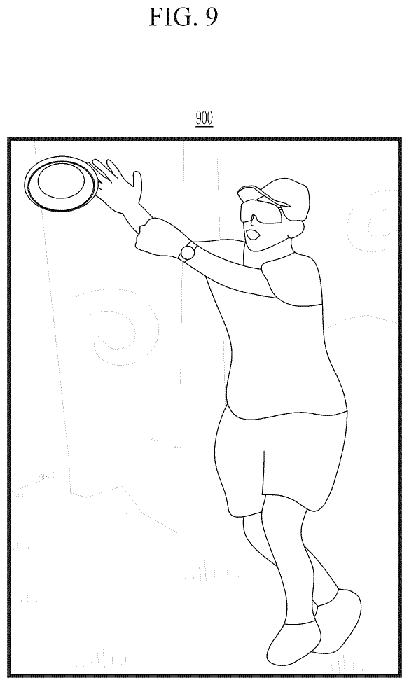

FIGS. 8 and 9 are drawings showing a second image according to some example embodiments.

Referring to FIGS. 8 and 9, the image signal processor 220 of FIG. 1 may crop the first region of interest 710 of FIG. 7 and the second region of interest 720 of FIG. 7 within a first image 700 of FIG. 7. The image signal processor 220 may perform upscaling to increase the sizes of the cropped the first region of interest 710 and the second region of interest 720. The resolution of the first region of interest 710 and the second region of interest 720 may be adjusted to the same level as the first image 700 in FIG. 7 through upscaling.

The image signal processor 220 may upscale the cropped the first region of interest 710 to generate a 2-1 image 800. The image signal processor 220 may display the 2-1 image 800 through the display panel 30 in FIG. 1.

The image signal processor 220 may upscale the cropped first region of interest 710 to generate a 2-2 image 900. The image signal processor 220 may display the 2-2 image 900 through the display panel 30.

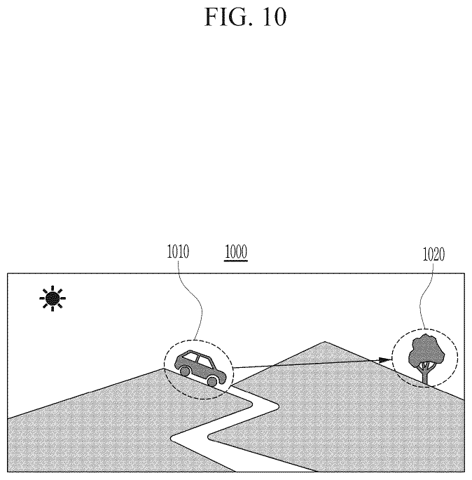

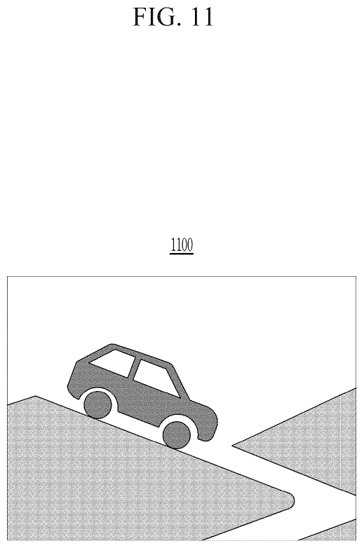

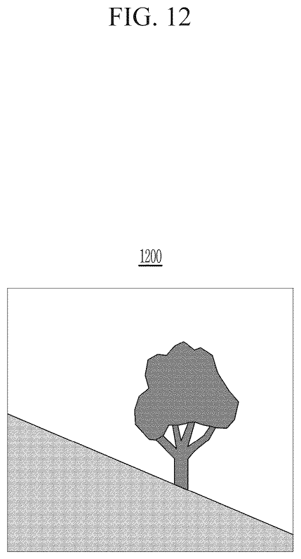

FIG. 10 is a drawing showing a user's swipe input on a display panel. FIG. 11 is a drawing showing a second-1 image generated based on a user's swipe input. FIG. 12 is a drawing showing a 2-2 image generated based on a user's swipe input.

Referring to FIG. 10, the display panel 30 of FIG. 1 may display a first image 1000. The first image 1000 may be generated through a binning operation targeting a raw image signal RIS of FIG. 1. The first image 1000 may include a first region of interest 1010 and a second region of interest 1020. For example, the first region of interest 1010 may include an object representing a car. The second region of interest 1020 may include an object representing a tree.

The display panel 30 may detect a user's swipe input starting from the first region of interest 1010 and moving toward the second region of interest 1020. An image signal processor 220 in FIG. 1 may crop the first region of interest 1010 within the first image 1000. The image signal processor 220 may perform upscaling to increase the size of the cropped first region of interest 1010. The image signal processor 220 may upscale the cropped first region of interest 1010 to generate a 2-1 image 1100. The resolution of the 2-1 image 1100 may be adjusted to the same level as the resolution of the first image 1000. The image signal processor 220 may display the 2-1 image 1100 through the display panel 30.

The image signal processor 220 may sequentially crop a plurality of intermediate regions arranged along a user's swipe input path from the first region of interest 1010 to the second region of interest 1020. The image signal processor 220 may perform upscaling on each of the plurality of intermediate regions to generate a plurality of second images. The image signal processor 220 may sequentially display a plurality of second images through the display panel 30.

The image signal processor 220 may crop the second region of interest 1020 within the first image 1000. The image signal processor 220 may perform upscaling to increase the size of the cropped second region of interest 1020. The image signal processor 220 may upscale the cropped second region of interest 1020 to generate a 2-2 image 1200. The resolution of the 2-2 image 1200 may be adjusted to the same level as the resolution of the first image 1000. The image signal processor 220 may display the 2-2 image 1200 through the display panel 30.

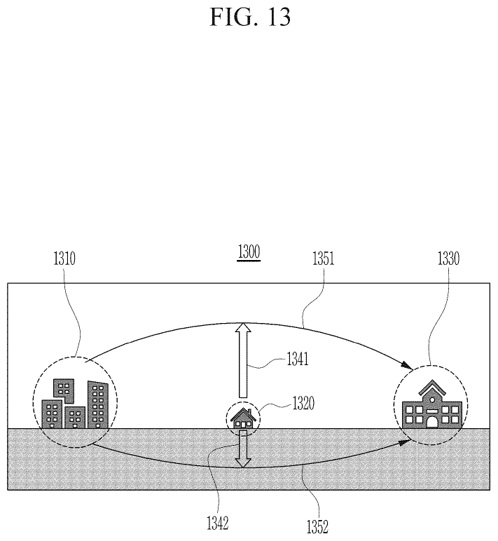

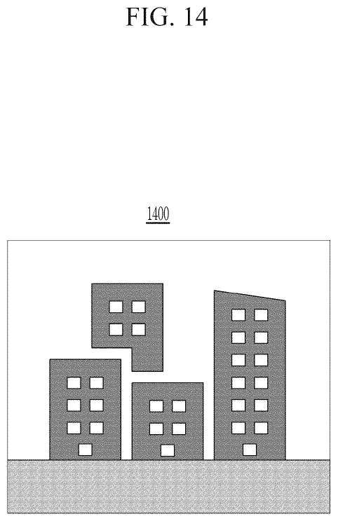

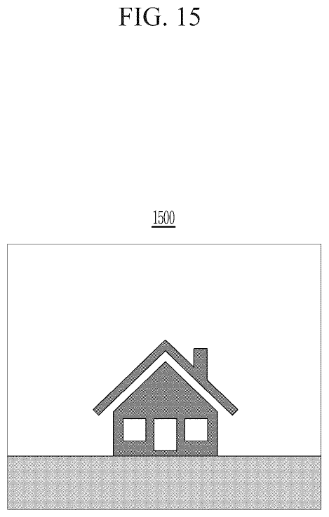

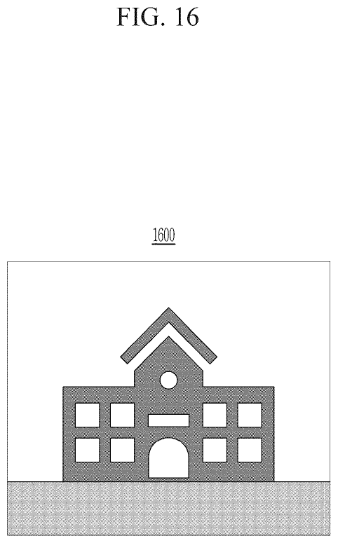

FIG. 13 is a diagram showing a user's zoom swipe input on a display panel. FIG. 14 is a drawing showing a second-1 image generated based on a user's zoom swipe input. FIG. 15 is a drawing showing a 2-2 image generated based on a user's zoom swipe input. FIG. 16 is a drawing showing a second-third image generated based on a user's zoom swipe input.

Referring to FIG. 13, the display panel 30 of FIG. 1 may display a first image 1300. The first image 1300 may be generated through a binning operation targeting a raw image signal RIS of FIG. 1. The first image 1300 may include a first region of interest 1310, a second region of interest 1320, and a third region of interest 1330. For example, the first region of interest 1310 may include an object representing an apartment. The second region of interest 1320 may include an object representing a house. The third region of interest 1330 may include an object representing a school.

The display panel 30 may detect a user's zoom swipe input starting from the first region of interest 1310, passing through the second region of interest 1320, and moving toward the third region of interest 1330. The zoom swipe input may differ from the swipe input of FIG. 10. The zoom swipe input may be based on a first swipe input 1351 and a second swipe input 1352 that are spaced apart from each other. The magnification ratios of the first region of interest 1310, the second region of interest 1320, and the third region of interest 1330 may be determined based on the interval between the first swipe input 1351 and the second swipe input 1352.

The interval between the first swipe input 1351 and the second swipe input 1352 may be determined by adding a first interval 1341 and a second interval 1342. The first interval 1341 may refer to the interval from one of the first region of interest 1310, the second region of interest 1320, and the third region of interest 1330 to the first swipe input 1351. The second interval 1342 may refer to the interval from one of the first region of interest 1310, the second region of interest 1320, and the third region of interest 1330 to the second swipe input 1352. For convenience of explanation, the explanation will continue assuming that the gap between the first swipe input 1351 and the second swipe input 1352 in the second region of interest 1320 is greater than the gap between the first swipe input 1351 and the second swipe input 1352 in the first region of interest 1310 or the third region of interest 1330.

The image signal processor 220 in FIG. 1 may crop the first region of interest 1310 within a first image 1300. The image signal processor 220 may perform upscaling to increase the size of the cropped first region of interest 1310. The image signal processor 220 may upscale the cropped first region of interest 1310 to generate a 2-1 image 1400. The resolution of the 2-1 image 1400 may be adjusted to the same level as the resolution of the first image 1300. The image signal processor 220 may display the 2-1 image 1400 through the display panel 30.

The image signal processor 220 may sequentially crop a plurality of intermediate regions arranged along a user's zoom swipe input path from the first region of interest 1310 to the second region of interest 1320. For example, the plurality of intermediate regions may include a first intermediate region adjacent to the first region of interest 1310 and a second intermediate region adjacent to the second region of interest 1320.

The image signal processor 220 may perform upscaling on each of the plurality of intermediate regions to generate a plurality of second images. The upscaling size of the second intermediate region may be larger than the upscaling size of the first intermediate region. The resolution of the image generated by upscaling the second intermediate region may be higher than the resolution of the image generated by upscaling the first intermediate region. The image signal processor 220 may sequentially display a plurality of second images through the display panel 30.

The image signal processor 220 may crop the second region of interest 1320 within the first image 1300. The image signal processor 220 may perform upscaling to increase the size of the cropped second region of interest 1320. The upscaling size of the second region of interest 1320 may be larger than the upscaling size of the first region of interest 1310. The image signal processor 220 may upscale the cropped second region of interest 1320 to generate a 2-2 image 1500. The resolution of the 2-2 image 1500 may be higher than the resolution of the first image 1300. The image signal processor 220 may display the 2-2 image 1500 through the display panel 30.

The image signal processor 220 may sequentially crop a plurality of intermediate regions arranged along the user's zoom swipe input path from the second region of interest 1320 to the third region of interest 1330. For example, the plurality of intermediate regions may include a third intermediate region adjacent to the second region of interest 1320 and a fourth intermediate region adjacent to the third region of interest 1330.

The image signal processor 220 may perform upscaling on each of the plurality of intermediate regions to generate a plurality of second images. The upscaling size of the third intermediate region may be larger than the upscaling size of the fourth intermediate region. The resolution of the image generated by upscaling the third intermediate region may be higher than the resolution of the image generated by upscaling the fourth intermediate region. The image signal processor 220 may sequentially display a plurality of second images through the display panel 30.

The image signal processor 220 may crop the third region of interest 1330 within the first image 1300. The image signal processor 220 may perform upscaling to increase the size of the cropped third region of interest 1330. The image signal processor 220 may upscale the cropped third region of interest 1330 to generate a 2-3 image 1600. The resolution of the 2-3 image 1600 may be adjusted to the same level as the resolution of the first image 1300. The image signal processor 220 may display the 2-3 image 1600 through the display panel 30.

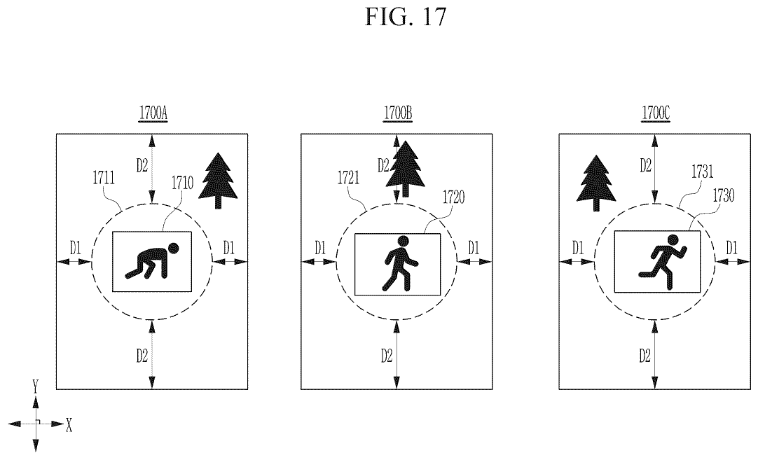

FIG. 17 is a drawing showing that the position of the region of interest on the display panel is fixed.

Referring to FIG. 17, the display panel 30 of FIG. 1 may display a 1-1 image 1700A in the first frame. The display panel 30 may display a 1-2 image 1700B in the second frame. The display panel 30 may display a 1-3 image 1700C in the 3rd frame. The first frame may be a point in time earlier than the second frame, and the second frame may be a point in time earlier than the third frame.

The 1-1 image 1700A to the 1-3 image 1700C may be generated through a binning operation targeting the raw image signal RIS of FIG. 1. The 1-1 image 1700A may include a 1-1 region of interest 1710. The 1-2 image 1700B may include a 1-2 region of interest 1720. The 1-3 image 1700C may include a 1-3 region of interest 1730. The 1-1 region of interest 1710 may include an object representing a stationary person. The 1-2 region of interest 1720 may include an object representing a walking person. The 1-3 region of interest 1730 may include an object representing a running person.

The 1-1 region of interest 1710 may be located within a 1-1 central region 1711. The 1-1 central region 1711 may be placed in a region spaced apart from vertical edges of the 1-1 image 1700A by a first distance D1 along a horizontal direction X, and may be spaced apart from horizontal edges of the 1-1 image 1700A by a second distance D2 along a vertical direction Y.

The 1-2 region of interest 1720 may be located within the 1-2 central region 1721. The 1-2 central region 1721 may be placed in a region spaced apart from vertical edges of the 1-2 image 1700B by the first distance D1 along the horizontal direction X, and may be spaced apart from horizontal edges of the 1-2 image 1700B by the second distance D2 along the vertical direction Y.

The 1-3 region of interest 1730 may be located within the 1-3 central region 1731. The 1-3 central region 1731 may be placed in a region spaced apart from vertical edges of the 1-3 image 1700C by the first distance D1 along the horizontal direction X, and may be spaced apart from horizontal edges of the 1-3 image 1700C by the second distance D2 along the vertical direction Y.

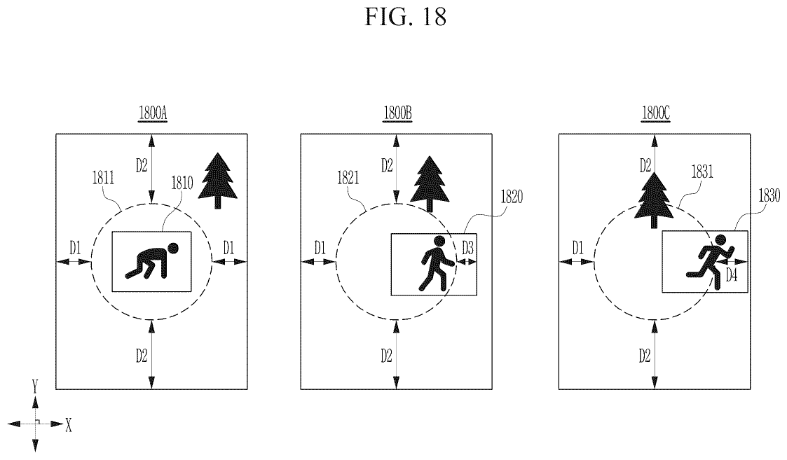

FIG. 18 is a drawing showing that the position of the region of interest on the display panel is not fixed.

Referring to FIG. 18, the display panel 30 of FIG. 1 may display a 1-1 image 1800A in the first frame. The display panel 30 may display a 1-2 image 1800B in the second frame. The display panel 30 may display a 1-3 image 1800C in the 3rd frame. The first frame may be a point in time earlier than the second frame, and the second frame may be a point in time earlier than the third frame.

The 1-1 image 1800A to the 1-3 image 1800C may be generated through a binning operation targeting the raw image signal RIS of FIG. 1. The 1-1 image 1800A may include a 1-1 region of interest 1810. The 1-2 image 1800B may include a 1-2 region of interest 1820. The 1-3 image 1800C may include a 1-3 region of interest 1830. The 1-1 region of interest 1810 may include an object representing a stationary person. The 1-2 region of interest 1820 may include an object representing a walking person. The 1-3 region of interest 1830 may include an object representing a running person.

The 1-1 region of interest 1810 may be located within a 1-1 central area 1811. The 1-1 central region 1811 may be placed in a region spaced apart from vertical edges of the 1-1 image 1800A by a first distance D1 along the horizontal direction X, and may be spaced apart from horizontal edges of the 1-1 image 1800A by a second distance D2 along the vertical direction Y.

The 1-2 region of interest 1820 may be placed in an area spaced a third distance D3 from a 1-2 central area 1821. The 1-2 central region 1821 may be placed in a region spaced apart from vertical edges of the 1-2 image 1800B by the first distance D1 along the horizontal direction X, and may be spaced apart from horizontal edges of the 1-2 image 1800B by the second distance D2 along the vertical direction Y.

The 1-3 region of interest 1830 may be placed in an area spaced a fourth interval D4 from the 1-3 central region 1831. The size of the fourth interval D4 may be larger than the size of the third interval D3. The 1-3 central region 1831 may be placed in a region spaced apart from vertical edges of the 1-3 image 1800C by the first distance D1 along the horizontal direction X, and may be spaced apart from horizontal edges of the 1-3 image 1800C by the second distance D2 along the vertical direction Y.

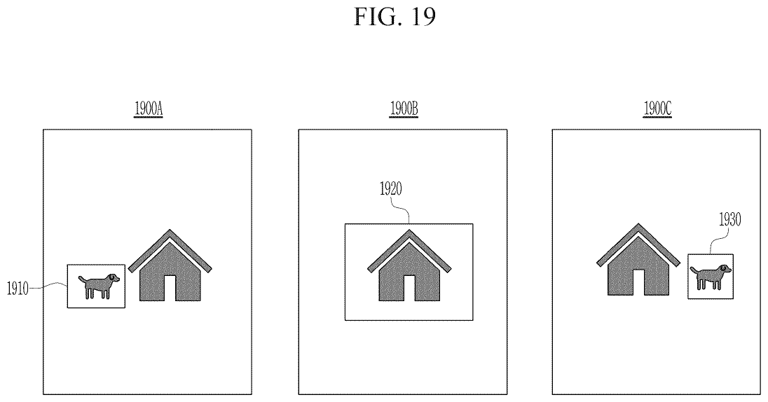

FIG. 19 is a drawing showing a some example embodiments where a subject corresponding to a region of interest on a display panel temporarily disappears.

Referring to FIG. 19, the display panel 30 of FIG. 1 may display a 1-1 image 1900A in the first frame. The display panel 30 may display a 1-2 image 1900B in the second frame. The display panel 30 may display a 1-3 image 1900C in the 3rd frame. The first frame may be a point in time earlier than the second frame, and the second frame may be a point in time earlier than the third frame.

The 1-1 image 1900A may include a 1-1 region of interest 1910. The 1-1 region of interest 1910 may include an object representing a walking dog. At some point between the first and second frame intervals, the puppy may temporarily disappear.

The 1-2 image 1900B may include a 1-2 region of interest 1920. The 1-2 region of interest 1920 may include an object indicating an area where the puppy has temporarily disappeared. The size of the 1-2 region of interest 1920 may be larger than the size of the 1-1 region of interest 1910. Between the second and third frame intervals, the puppy that had disappeared may reappear.

The 1-3 image 1900C may include a 1-3 region of interest 1930. The 1-3 region of interest 1930 may contain an object representing a walking dog. The size of the 1-3 region of interest 1930 may be smaller than the size of the 1-2 region of interest 1920.

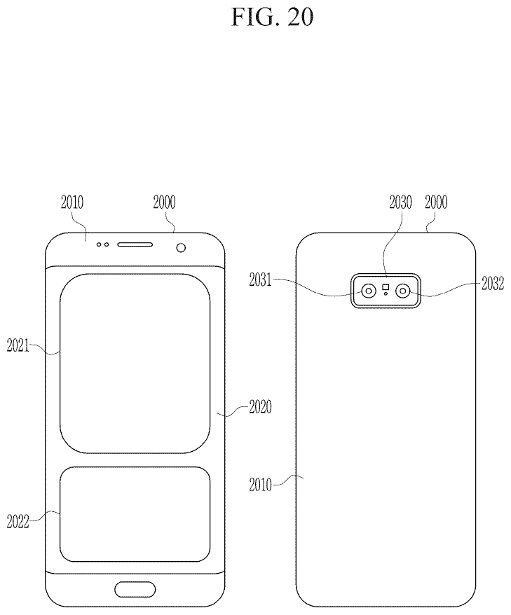

FIG. 20 is a front view and a back view of an electronic device according to some example embodiments.

Referring to FIG. 10, an electronic device 2000 may include a housing 2010, a display panel 2020, and a camera device 2030. The housing 2010 may protect components inside the electronic device 2000. For example, the housing 2010 may include a first surface forming a front surface of the electronic device 2000. The housing 2010 may include a second side facing opposite the first side and forming a rear surface of the electronic device 2000. The housing 2010 may include a side surface surrounding a space between the first side and the second side.

The display panel 2020 may be exposed through the first side of the housing 2010. The display panel 2020 may be exposed through the cover glass. The display panel 2020 may include a first region 2021 and a second region 2022. The size of the second region 2022 may be smaller than the size of the first region 2021. A first image 700 of FIG. 7 may be displayed in the first region 2021. A second image 800 of FIG. 8 or 900 of FIG. 9 may be displayed in the second region 2022. The second image 800 in FIG. 8 or 900 in FIG. 9 may be displayed in a PIP (Picture in Picture) format.

The camera device 2030 may be placed on the rear of the electronic device 2000. The camera device 2030 may include a first camera 2031 and a second camera 2032. The first camera 2031 and the second camera 2032 may be exposed through the second side of the housing 2010. The first camera 2031 and the second camera 2032 may be positioned to face the same direction. The first camera 2031 and the second camera 2032 may include the same type of lens or may include different types of lenses. The number of cameras included in the camera device 2030 is for illustrative purposes only.

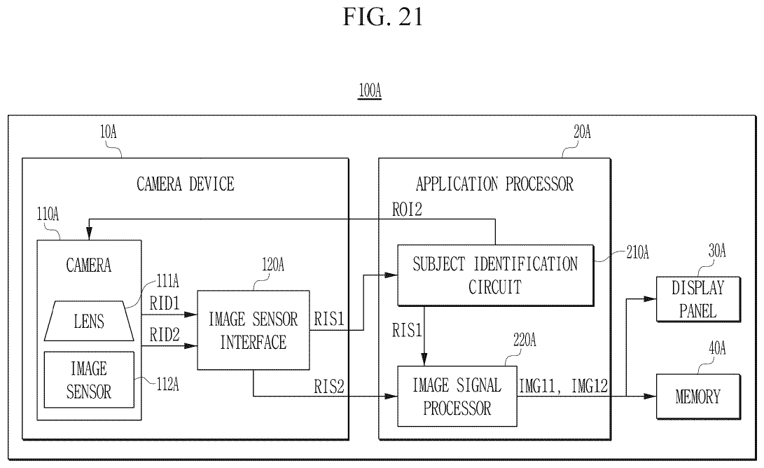

FIG. 21 is a block diagram of an electronic device according to some example embodiments.

Referring to FIG. 21, the electronic device 100A may be a modified example of the electronic device 100 of FIG. 1. The camera device 10A, application processor 20A, display panel 30A, and memory 40A included in the electronic device 100A may each correspond to the camera device 10, application processor 20, display panel 30, and memory 40 included in the electronic device 100.

The camera device 110A may receive a region of interest signal ROI2 from a subject identification circuit 210A. The region of interest signal ROI2 may correspond to the region of interest signal ROI of FIG. 1. The camera device 110A may capture a subject frame by frame based on the region of interest signal ROI2 to generate a second raw image data RID2. The second raw image data RID2 may be different from the first raw image data RID1. The first raw image data RID1 may correspond to the raw image data RID of FIG. 1. The point in time at which the first raw image data RID1 is generated may be the first frame, and the point in time at which the second raw image data RID2 is generated may be the second frame. The first frame may be earlier than the second frame.

The second raw image data RID2 may be generated by cropping by the image sensor 112A. The image sensor 112A may generate the second raw image data RID2 by cropping an area within the raw image data in the second frame corresponding to the region of interest signal ROI2 using offset information of a first image IMG11. In some example embodiments, the cropping operation of the image signal processor 220A may be omitted. The offset information of the first image IMG11 may correspond to the offset information of the first image IMG1 of FIG. 1.

The image sensor interface 120A may convert the second raw image data RID2 into a second raw image signal RIS2 and transmit it to the image signal processor 220A. The image signal processor 220A may receive a first raw image signal RIS1 from the subject identification circuit 210A. The image signal processor 220A may receive the second raw image signal RIS2 from the image sensor interface 120A. The image signal processor 220A may perform a binning operation on the first raw image signal RIS1 to generate the first image IMG11. The image signal processor 220A may generate a second image IMG12 without cropping the first image IMG11. The image signal processor 220A may generate the second image IMG12 based on the second raw image signal RIS2. The resolution of the first image IMG11 may be lower than the resolution of the second image IMG12.

The second image IMG12 generated by the image signal processor 220A may have a higher resolution than the second image IMG2 generated by the image signal processor 220 of FIG. 1. When a part of an area within a first image IMG1 of FIG. 1 is cropped to generate a second image IMG2 of FIG. 1, the resolution of the second image IMG2 may be reduced due to a pixel interpolation effect. Additionally, performing upscaling to maintain resolution after cropping may result in additional operations, which may degrade the performance of the image signal processor 220. Accordingly, the second image IMG12 generated by the image signal processor 220A may have a higher resolution than the second image IMG2 generated by the image signal processor 220.

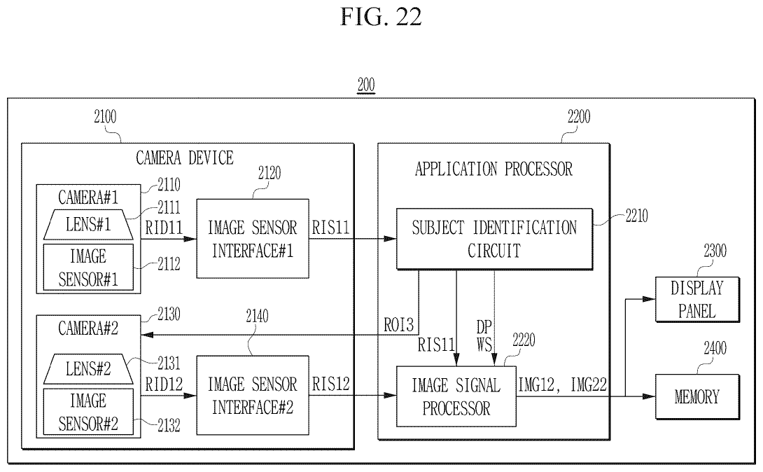

FIG. 22 is a block diagram of an electronic device according to some example embodiments.

Referring to FIG. 22, the electronic device 200 may be a modified example of the electronic device 100 of FIG. 1. The camera device 2100, application processor 2200, display panel 2300, and memory 2400 included in the electronic device 200 may each correspond to the camera device 10, application processor 20, display panel 30, and memory 40 included in the electronic device 100.

The camera device 2100 may include a first camera 2110 and a second camera 2130. The first camera 2110 may include a first lens 2111 and a first image sensor 2112. The second camera 2130 may include a second lens 2131 and a second image sensor 2132. The angle of view of the first lens 2111 may be larger than the angle of view of the second lens 2131. For example, if the first lens 2111 is an ultra wide-angle lens, the second lens 2131 may be a wide-angle lens or a telephoto lens. If the first lens 2111 is a wide-angle lens, the second lens 2131 may be a telephoto lens. An ultra-wide-angle lens has a focal length less than 24 mm and an angle of view greater than 110° and less than 120°. A wide-angle lens may have a focal length greater than 24 mm and less than or equal to 35 mm, and an angle of view greater than or equal to 78° and less than or equal to 80°. A telephoto lens may have a focal length greater than 35 mm and an angle of view less than 60°. The focal lengths and angles of view of ultra wide-angle lenses, wide-angle lenses, and telephoto lenses are examples only. For purposes of description only, it is assumed in the following that the first lens 2111 is an ultra-wide-angle lens and the second lens 2131 is a wide-angle lens.

The first image sensor 2112 may include a first pixel array. The first pixel array may include a plurality of first pixels. The second image sensor 2132 may include a second pixel array. The second pixel array may include a plurality of second pixels. The second pixel may have more than 200 million. However, the number of second pixels may be less than the number of first pixels. The second image sensor 2132 may implement a resolution of 200 MP Megapixel or higher.

The first camera 2110 may receive optical signals reflected from the plurality of subjects through the first lens 2111 on a frame-by-frame basis. The first image sensor 2112 may generate first raw image data RID11 based on an optical signal collected through the first lens 2111. The first image sensor interface 2120 may serialize the first raw image data RID11 and convert it into a first raw image signal RIS11 in the same frame unit. The first raw image data RID11 and the first raw image signal RIS11 may correspond to the raw image data RID and the first raw image signal RIS11 of FIG. 1, respectively.

The subject identification circuit 2210 may receive the first raw image signal RIS11 from the image sensor interface 2120. The subject identification circuit 2210 may detect a subject based on the first raw image signal RIS11 and determine information on a candidate region of interest based on the moving speed of the subject. Information about candidate regions of interest may include the plurality of candidate regions of interest.

The subject identification circuit 2210 may select at least one region of interest candidate from among a plurality of region of interest candidates to generate a region of interest signal ROI3. The subject identification circuit 2210 may transmit the first raw image signal RIS11 to the image signal processor 2220. The subject identification circuit 2210 may transmit the region of interest signal ROI3 containing offset information to the second camera 2130. The region of interest signal ROI3 and offset information may correspond to the region of interest signal ROI and offset information of FIG. 1, respectively.

The subject identification circuit 2210 may calculate the movement distance of the plurality of subjects based on the movement speeds of the plurality of subjects and the positions of the plurality of subjects corresponding to the plurality of region of interest candidates. The subject identification circuit 2210 may select a region of interest candidate corresponding to a subject whose movement distance is greater than a first threshold distance from among a plurality of subjects and generate a field of view deviation signal DS. The subject identification circuit 2210 may calculate the probability that a subject corresponding to a region of interest candidate will depart from the first field of view based on a field of view deviation signal DS. The subject identification circuit 2210 may generate a warning signal WS when an information DP exceeds a first reference value. A view deviation calculator 2213 may transmit the angle of the view deviation information DP and a warning signal WS to the image signal processor 222.

The second camera 2130 may generate second raw image data RID12 based on the region of interest signal ROI3 containing offset information. The second camera 2130 may receive optical signals reflected from the plurality of subjects through the second lens 2131 on a frame-by-frame basis. The second image sensor 2132 may generate second raw image data RID12 based on an optical signal collected through the second lens 2131. The second raw image data RID12 may only include image data corresponding to the region of interest signal ROI3. The second raw image data RID12 may be generated from a frame after the first raw image data RID11 is generated.

The second camera 2130 may transmit second raw image data RID12 to the second image sensor interface 2140. The second image sensor interface 2140 may serialize the second raw image data RID12 and convert it into a second raw image signal RIS12 in the same frame unit. The second image sensor interface 2140 may transmit the second raw image signal RIS12 to the image signal processor 2220.

The image signal processor 2220 may generate a first image IMG12 based on the first raw image signal RIS11. The image signal processor 2220 may generate a second image IMG22 based on the second raw image signal RIS12. The first image IMG12 may have a lower resolution than the second image IMG22. The image signal processor 2220 may transmit the first image IMG12 and the second image IMG22 to the display panel 2300 and the memory 2400.

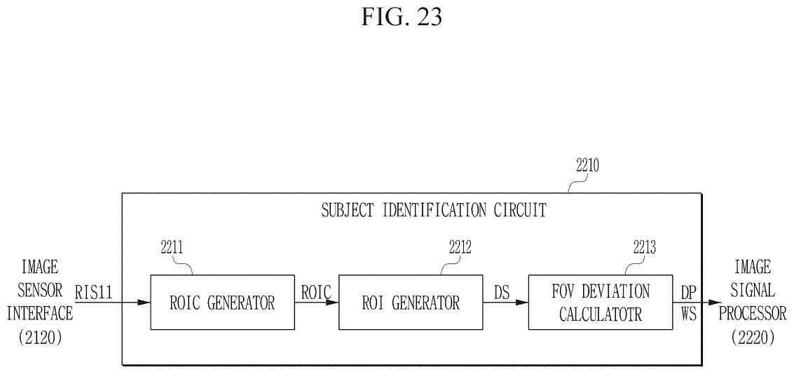

FIG. 23 is a block diagram of a subject identification circuit according to some example embodiments.

Referring to FIG. 23, the subject identification circuit 2210 may include a region of interest candidate generator 2211, a region of interest signal generator 2212, and the view deviation calculator 2213. The region of interest candidate generator 2211 may receive the first raw image signal RIS11 from the image sensor interface 2120. The first raw image signal RIS11 may include identification information for the plurality of subjects and movement speed information of the plurality of subjects. The operation of the region of interest candidate generator 2211 to determine information about the region of interest candidate ROIC is identical to that of FIG. 2.

The region of interest signal generator 2212 may receive information about the region of interest candidate ROIC from the region of interest candidate generator 2211. Information about the region of interest candidate ROIC may include the plurality of candidate regions of interest. The region of interest signal generator 2212 may calculate the movement distance of the plurality of subjects based on the movement speeds of the plurality of subjects and the positions of the plurality of subjects corresponding to the plurality of region of interest candidates. The moving speed of the subject may mean the moving speed of the region of interest corresponding to the subject on the display panel 2300. The location of the subject may mean the location on the display panel 2300 of the region of interest corresponding to the subject. The movement distance of the subject may mean the movement distance of the region of interest corresponding to the subject on the display panel 2300.

The region of interest signal generator 2212 may obtain the moving speed of the subject based on a first position on the display panel 2300 of the region of interest corresponding to the subject at a first frame point in time and a second position on the display panel 2300 of the region of interest corresponding to the subject at a second frame point in time after the first frame point in time. The region of interest signal generator 2212 may receive location information corresponding to the first location and the second location from the display panel 2300.

The region of interest signal generator 2212 may calculate the moving distance of the subject based on the acquired moving speed of the subject and the position of the subject in the second frame. The distance the subject moved may mean the distance the subject moved from the second frame point to the third frame point.

The region of interest signal generator 2212 may select a region of interest candidate corresponding to a subject whose movement distance is greater than a first threshold distance from among a plurality of subjects and generate a field of view deviation signal DS.

Among the plurality of subjects, a subject whose movement distance is greater than the first threshold distance may have a high probability of leaving the first angle of view of the first camera 2110 of FIG. 12.

The first threshold distance may vary depending on the location of the region of interest corresponding to the subject on the display panel 2300. For example, the value of the first threshold distance when the region of interest corresponding to the first subject is at the center on the display panel 2300 may be greater than the value of the first threshold distance when the region of interest corresponding to the second subject is at the edge on the display panel 2300.

The view deviation calculator 2213 may receive a field of view deviation signal DS from a region of interest signal generator 2212. The view deviation calculator 2213 may calculate the probability that a subject corresponding to a region of interest candidate will depart from the first field of view based on a field of view deviation signal DS. The probability that the subject will leave the first angle of view may be calculated based on the subject's position in previous frames, the average velocity calculated based on the change in position, and the subject's current position.

The view deviation calculator 2213 may generate the angle of the view deviation information DP as probability information that a subject will deviate from the first angle of view. The view deviation calculator 2213 may generate a warning signal WS when the angle of the view deviation information DP exceeds a first reference value. The view deviation calculator 2213 may transmit the angle of the view deviation information DP and a warning signal WS to the image signal processor 222.

The view deviation calculator 2213 may generate the probability that a subject whose moving distance is greater than a first threshold distance will deviate from the first angle of view as angle of the view deviation information DP of the subject. The view deviation calculator 2213 may generate a warning signal WS when the angle of the view deviation information DP exceeds a first reference value.

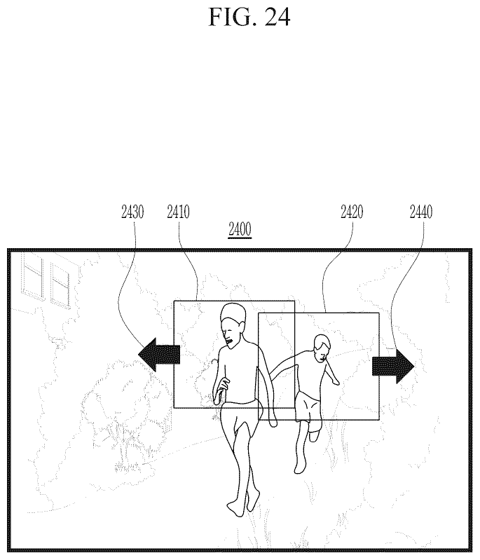

FIG. 24 is a drawing showing a first image and guide object according to some example embodiments.

Referring to FIG. 6 and FIG. 24, the image signal processor 2220 of FIG. 22 may generate a first image 2400 through a binning operation targeting the first raw image signal RIS11 of FIG. 22. The binning ratio may be 16:1. The image signal processor 2220 may display the first image 2400 through the display panel 2300 of FIG. 22. The first image 2400 may have 4K resolution. Binning ratios and resolutions are examples only.

The first image 2400 may include a first region of interest 2410 and a second region of interest 2420. The first region of interest 2410 may be generated based on the field of view deviation signal DS of the first subject. A second region of interest 2420 may be generated based on a field of view deviation signal DS of the second subject. The image signal processor 2220 may display a first region of interest 2410 and a second region of interest 2420 within a first image 2400 through a display panel 2300.

The image signal processor 2220 may display a first guide object 2430 in an adjacent area of the first region of interest 2410 through the display panel 2300. The image signal processor 2220 may display a second guide object 2440 in an adjacent area of the second region of interest 2420 through the display panel 2300.

If the value of the angle of view deviation information of the first subject corresponding to the first region of interest 2410 is greater than the value of the angle of view deviation information of the second subject corresponding to the second region of interest 2420, the image signal processor 2220 may display the first guide object 2430 larger than the second guide object 2440 through the display panel.

The first region of interest 2410, the second region of interest 2420, the first guide object 2430, and the second guide object 2440 included in the first image 2400 may be displayed in the first region 2021 of the display panel 2020 of FIG. 20.

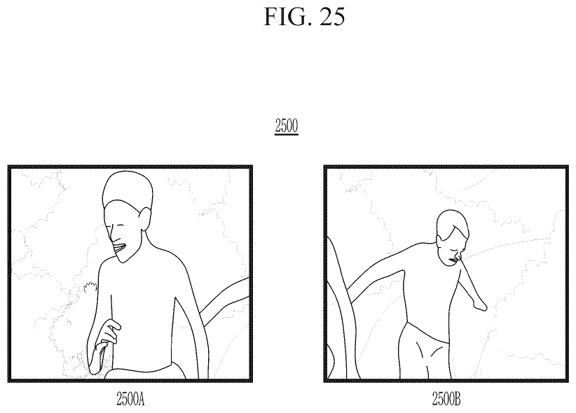

FIG. 25 is a drawing showing a second image according to some example embodiments.

Referring to FIG. 22 and FIG. 25, the second camera 2130 may generate raw image data RID12 based on the region of interest signal ROI3 received from the subject identification circuit 2210. The raw image data RID12 may only contain image data for the region of interest corresponding to the region of interest signal ROI3. Raw image data RID12 may be serialized and converted into raw image signals RIS12. The image signal processor 2220 may generate a second image 2500 based on the raw image signal RIS12. The image signal processor 2220 may generate the second image 2500 without cropping the region of interest of the first image 2400 of FIG. 24.

The second image 2500 may include a 2-1 image 2500A and a 2-2 image 2500B. The 2-1 image 2500A may correspond to the first region of interest 2410 of FIG. 24. The 2-2 image 2500B may correspond to the second region of interest 2420 of FIG. 24. The image signal processor 2220 may display the 2-1 image 2500A and the 2-2 image 2500B through the display panel 2300. The 2-1 image 2500A and the 2-2 image 2500B may be displayed in the second region 2022 of the display panel 2020 of FIG. 20.

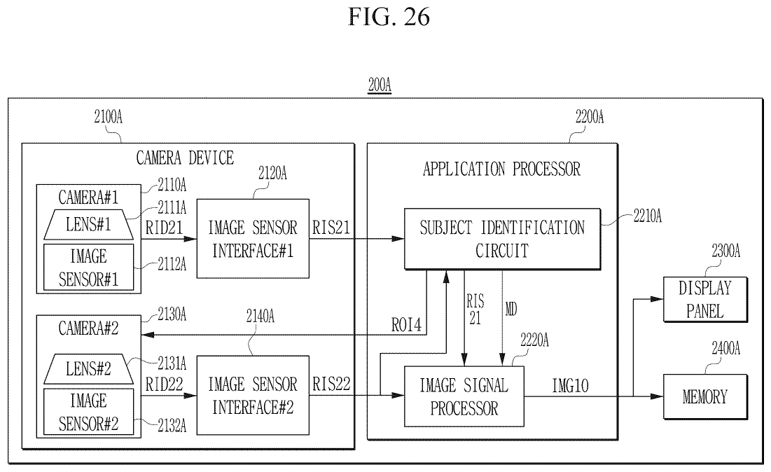

FIG. 26 is a block diagram of an electronic device according to some example embodiments.

Referring to FIG. 26, an electronic device 200A may be a modified example of the electronic device 200 of FIG. 22. The camera device 2100A, application processor 2200A, display panel 2300A, and memory 2400A included in the electronic device 200A may each correspond to the camera device 2100, application processor 2200, display panel 2300, and memory 2400 included in the electronic device 200.

The camera device 2100A may include a first camera 2110A and a second camera 2130A. The first camera 2110A may include a first lens 2111A and a first image sensor 2112A. The second camera 2130A may include a second lens 2131A and a second image sensor 2132A. The angle of view of the first lens 2111A may be larger than the angle of view of the second lens 2131A. For purposes of description only, it is assumed in the following that the first lens 2111A is an ultra-wide-angle lens and the second lens 2131A is a wide-angle lens.

The first camera 2110A may receive optical signals reflected from the plurality of subjects through the first lens 2111A on a frame-by-frame basis. The first image sensor 2112A may generate first raw image data RID21 based on an optical signal collected through the first lens 2111A.

The first camera 2110A may capture images with a 4:3 ratio at 30 fps and output first raw image data RID21 with a resolution of 12.5 megapixels (MP). The exposure integration time of the first camera 2110A may be set to a maximum of less than 7.15 ms. A plurality of raw image data output from the first camera 2110A at a point in time prior to the shooting timing may be temporarily stored. At the time of the user's shooting input, first raw image data RID21 may be generated based on the plurality of temporarily stored raw image data. When the plurality of raw image data have different exposure conditions, the plurality of raw image data may be combined to generate first raw image data RID21 with improved dynamic range.

The first image sensor interface 2120A may serialize the first raw image data RID21 and convert it into a first raw image signal RIS21 in the same frame unit. The first raw image data RID21 and the first raw image signal RIS21 may correspond to the raw image data RID11 and the first raw image signal RIS12 of FIG. 22, respectively.

The subject identification circuit 2210A may receive a first raw image signal RIS21 from the image sensor interface 2120A. The subject identification circuit 2210A may detect a subject based on the first raw image signal RIS21 and generate a region of interest signal ROI4 based on the moving speed of the subject. The subject identification circuit 2210A may transmit the first raw image signal RIS21 to the image signal processor 2220A. The subject identification circuit 2210A may transmit a region of interest signal ROI4 to the second camera 2130A. The region of interest signal ROI4 may correspond to the region of interest signal ROI3 of FIG. 22.

The second camera 2130A may receive a region of interest signal ROI4 from the subject identification circuit 2210A. The second camera 2130A may capture an image with a 16:9 ratio at 30 fps based on a region of interest signal ROI4 and output second raw image data RID22 with a 4K resolution. The exposure integration time of the second camera 2130A may be set to less than 9.1 ms. The second raw image data RID22 may be provided at a resolution more advantageous for detailed expression than the first raw image data RID21.

The second camera 2130A may transmit second raw image data RID22 to the second image sensor interface 2140A. The second image sensor interface 2140A may serialize the second raw image data RID22 and convert it into a second raw image signal RIS22 in the same frame unit. The second image sensor interface 2140A may transmit the second raw image signal RIS22 to the subject identification circuit 2210A and the image signal processor 2220A.

The subject identification circuit 2210A may receive a first raw image signal RIS21 and a second raw image signal RIS22. The subject identification circuit 2210A may analyze the main subject features included in each of the first raw image signal RIS21 and the second raw image signal RIS22. Key subject features may include edges where there is a sharp change in brightness, outlines defining the outer shape of the object, and corner points corresponding to points where two or more edges intersect.

The subject identification circuit 2210A may perform matching for the same subject between the first raw image signal RIS21 and the second raw image signal RIS22 based on the features of the main subject. The subject identification circuit 2210A may output the result of matching between the first raw image signal RIS21 and the second raw image signal RIS22 as a first matching result MD to the image signal processor 2220A.

The image signal processor 2220A may separate the main subject within the second raw image signal RIS22 from the background area. For example, the image signal processor 2220A may blur the background area to visually isolate the main subject.

The image signal processor 2220A may generate a combined image by combining the separated main subject within the second raw image signal RIS22 and the first raw image signal RIS21 based on the first matching result MD. The combined image may reduce distortion between the separated main subject within the second raw image signal RIS22 and the main subject of the first raw image signal RIS21.

The image signal processor 2220A may generate a first image IMG10 by performing blending to correct color differences, brightness mismatches, and boundary heterogeneity that occur during the process of generating a combined image. For example, the image signal processor 2220A may process the combined unknown boundary so that it is naturally connected by applying a Gaussian pyramid-based multi-scale technique. The image signal processor 2220A may transmit the first image IMG10 to the display panel 2300A and the memory 2400A.

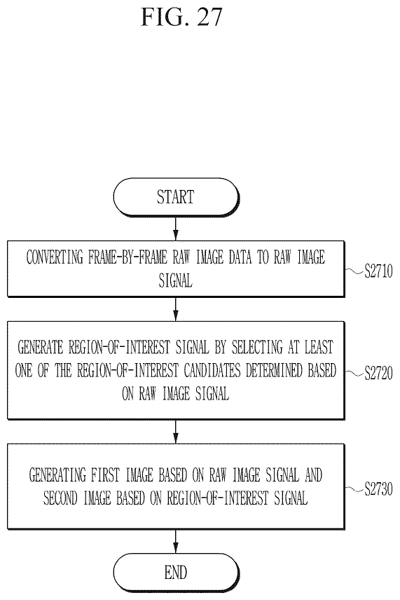

FIG. 27 is a flowchart showing the process of generating the first image and the second image.

Referring to FIG. 27, in operation S2710, the electronic device may generate a raw image signal on a frame-by-frame basis. The raw image signal RIS may be converted by serializing the raw image data RID.

In operation S2720, the electronic device may determine information about a group of region of interest candidates based on the raw image signal and indicate at least one region of interest candidate among a plurality of region of interest candidates included in the information about the group of region of interest candidates.

The electronic device may determine information about a candidate region of interest based on identification information of a plurality of subjects and movement speed information of the plurality of subjects.

The electronic device may generate a region of interest signal by selecting a region of interest candidate that is identical to a plurality of previous region of interest candidates included in the information about the region of interest candidate group.

In operation S2730, the electronic device may generate a first image based on the raw image signal and generate a second image based on the region of interest signal. The first image and the second image may be displayed on a display panel (e.g., 30 in FIG. 1) on different areas of the display panel. The first image may have a lower resolution than the second image.

An electronic device according to some example embodiments may include an image signal processor that crops a first region of interest from the first image and upscales the cropped first region of interest to generate a 2-1 image, sequentially crops a plurality of intermediate regions arranged along a path corresponding to a swipe input from the first region of interest to a second region of interest in the first image, performs upscaling on the cropped intermediate regions to generate a plurality of second images, crops a second region of interest from the first image, and upscales the cropped second region of interest to generate a 2-2 image, and a display panel that sequentially displays the 2-1 image, the plurality of second images, and the 2-2 image.

In some example embodiments, the swipe input includes a first swipe input and a second swipe input that are spaced apart from each other, and an upscaling ratio of each of the first region of interest, the plurality of intermediate regions, and the second region of interest may be determined based on the spacing between the first swipe input and the second swipe input.

In some example embodiments, the distance between the first swipe input and the second swipe input may be determined by adding up distances of the first swipe input and the second swipe input from one of the first region of interest, the plurality of intermediate regions, or the second region of interest.

In some example embodiments, if the distance between the first swipe input and the second swipe input exceeds a first threshold, the upscaling ratio of the first region of interest, the plurality of intermediate regions, or the second region of interest may be a first scale. If the distance between the first swipe input and the second swipe input is less than the first threshold, the upscaling ratio of the first region of interest, the plurality of intermediate regions, or the second region of interest may be a second scale that is smaller than the first scale.

An electronic device according to some example embodiments may include an image signal processor that performs binning processing on a raw image signal to generate a plurality of frame images, extracts a region of interest for each of the plurality of frame images, and arranges a region of interest in a central region spaced apart by a first horizontal distance and a second vertical distance within the frame image, and a display panel that sequentially displays a plurality of frame images in which the region of interest is arranged in the central region.

An electronic device according to some example embodiments may include an image signal processor that extracts a first region of interest in which an object of interest exists for a plurality of frame images, and if the object of interest is not detected, extracts a second region of interest including an area in which the object of interest disappears, and sets a size of the second region of interest to be larger than a size of the first region of interest, and if the object of interest reappears, extracts a third region of interest including the object of interest, and sets a size of the third region of interest to be smaller than a size of the second region of interest, and a display panel that sequentially displays frame images including the first region of interest to the third region of interest.

One or more of the elements disclosed above may include or be implemented in processing circuitry such as hardware including logic circuits; a hardware/software combination such as a processor executing software; or a combination thereof. For example, the processing circuitry may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, an application-specific integrated circuit (ASIC), etc.

Although some example embodiments of the present inventive concepts have been described in detail above, the scope of the present inventive concepts is not limited thereto, and various modifications and improvements made by those skilled in the art using the basic concept of the present inventive concepts defined in the following claims also fall within the scope of the present inventive concepts.

What is claimed is:

1. An electronic device, comprising:
a camera device configured to generate a raw image signal on a frame-by-frame basis;
a subject identification circuit configured to determine information on a group of region of interest candidates based on the raw image signal and generate a region of interest signal indicating at least one region of interest candidate among a plurality of region of interest candidates included in the information on the group of region of interest candidates;
an image signal processor configured to generate a first image based on the raw image signal, and generate a second image based on the region of interest signal,
wherein the region of interest signal includes offset information, and the offset information is a distance from a center region of the first image to the at least one region of interest candidate; and
a display panel configured to display the first image and the second image.

2. The electronic device of claim 1, wherein the subject identification circuit is configured to
identify a subject captured by the camera device and a moving speed of the subject based on the raw image signal;
generate subject identification information and moving speed information based on the subject and the moving speed identified; and
determine the information on the group of region of interest candidates based on the subject identification information and the moving speed information.

3. The electronic device of claim 2, wherein the subject identification circuit is further configured to
obtain information about a previous region of interest candidate group determined based on a previous raw image signal generated in a frame before the raw image signal is generated;
select the at least one region of interest candidate included in the information on the group of region of interest candidates that is identical to a plurality of previous region of interest candidates included in the information about the previous region of interest candidate group; and
generate the region of interest signal based on the at least one region of interest candidate selected.

4. The electronic device of claim 2, wherein the subject identification circuit is further configured to
receive an input indicating at least one user selected region of interest candidate among the group of region of interest candidates included in information about a user region of interest candidate group; and
generate the region of interest signal based on the at least one user selected region of interest candidate.

5. The electronic device of claim 3, wherein the subject identification circuit is further configured to
perform a binning operation on the raw image signal to generate the first image; and
crop a partial region within the first image corresponding to the region of interest signal to generate the second image.

6. The electronic device of claim 5, wherein
the first image has a first resolution and the second image has a second resolution, and the first resolution is lower than the second resolution.

7. The electronic device of claim 1, wherein
the image signal processor is further configured to display information about the first image and the at least one region of interest candidate in a first area of the display panel, and display the second image in a second area of the display panel that is different from the first area.

8. The electronic device of claim 5, wherein
the camera device is further configured to receive the region of interest signal from the subject identification circuit, and generate a second raw image signal cropped from a second frame after a first raw image signal is generated from a first frame based on the region of interest signal, and
the image signal processor is further configured to generate the second image based on the second raw image signal.

9. The electronic device of claim 1, wherein
the image signal processor is further configured to perform a binning operation on the raw image signal to generate the first image, the first image having a first resolution and the second image having a second resolution, the first resolution being lower than the second resolution.

10. An electronic device, comprising:
a first camera configured to generate first raw image data on a frame-by-frame basis;
a subject identification circuit configured to determine information about a group of region of interest candidates based on the first raw image data and generate a region of interest signal indicating at least one region of interest candidate among a plurality of region of interest candidates included in the information about the group of region of interest candidates;
a second camera configured to generate second raw image data based on the region of interest signal;
an image signal processor configured to generate a first image based on the first raw image data, and generate a second image based on the second raw image data,
wherein the region of interest signal includes offset information, and the offset information is a distance from a center region of the first image to the at least one region of interest candidate; and
a display panel configured to display the first image and the second image.

11. The electronic device of claim 10, wherein
the first camera includes a first lens and a first image sensor, the first lens has a first angle of view, and the first image sensor includes a plurality of first pixels,
the second camera includes a second lens and a second image sensor, the second lens has a second angle of view smaller than the first angle of view, and the second image sensor includes a plurality of second pixels, and
a number of the plurality of first pixels is greater than a number of the plurality of second pixels.

12. The electronic device of claim 11, wherein the subject identification circuit is further configured to
calculate a movement distance of a plurality of subjects captured by the first camera, the movement distance being calculated from positions of the plurality of subjects based on movement speeds of the plurality of subjects corresponding to the plurality of region of interest candidates and the positions of the plurality of subjects,
select the at least one region of interest candidate corresponding to a subject from among the plurality of subjects having movement distance greater than a first threshold distance, and
generate the region of interest signal based on the at least one region of interest candidate selected.

13. The electronic device of claim 12, wherein the subject identification circuit is further configured to
generate a probability that the subject from among the plurality of subjects having movement distance greater than the first threshold distance deviates from the first angle of view as angle of view deviation information of the subject from among the plurality of subjects, and
generate a warning signal responsive to a value of the angle of view deviation information exceeding a first reference value.

14. The electronic device of claim 13, wherein
the image signal processor is further configured to display, in a first area of the display panel, information about the first image and information about the at least one region of interest candidate, and display the second image in a second area of the display panel that is different from the first area.

15. The electronic device of claim 14, wherein
the image signal processor is further configured to display, in the first area of the display panel, a guide object indicating the warning signal in an adjacent area of the subject from among the plurality of subjects corresponding to the information about the at least one region of interest candidate.

16. The electronic device of claim 15, wherein
responsive to subjects corresponding to the information about the group of region of interest candidates including a first subject having a first value of the angle of view deviation information and a second subject having a second value of the angle of view deviation information smaller than the first value of the angle of the view deviation information, the image signal processor is further configured to display on the display panel a first guide object in an area adjacent to the first subject and display a second guide object on the display panel in an area adjacent to the second subject, and a size of the second guide object is smaller than a size of the first guide object.

17. The electronic device of claim 10, wherein
the second camera is further configured to receive the region of interest signal from the subject identification circuit and generate the second raw image data corresponding to the region of interest signal.

18. The electronic device of claim 17, wherein
the first image has a first resolution and the second image has a second resolution, and the first resolution is lower than the second resolution.

19. An operation method of an electronic device comprising:
generating, by an image sensor, raw image data on a frame-by-frame basis;
converting, by an image sensor interface, the raw image data into a raw image signal;
determining, by a subject identification circuit, information on a group of region of interest candidates based on the raw image signal;
generating, by the subject identification circuit, a region of interest signal indicating at least one region of interest candidate among a plurality of region of interest candidates included in the information on the group of region of interest candidates;
generating, by an image signal processor, a first image based on the raw image signal;
generating, by the image signal processor, a second image based on the region of interest signal,
wherein the region of interest signal includes offset information, and the offset information is a distance from a center region of the first image to the at least one region of interest candidate; and
displaying the first image and the second image in different areas on a display panel.

20. The operation method of the electronic device of claim 19, wherein
the first image is generated as having a first resolution and the second image is generated as having a second resolution, and the first resolution is lower than the second resolution.
